(19) United States
(12) Patent Application Publication
(10) Pub. No.: US 2014/0349662 A1
(43) Pub. Date: Nov. 27, 2014

(54) ADVANCED CIRCUIT SWITCHED FALLBACK CONNECTION ESTABLISHMENT WITH IDLE MODE SIGNALING REDUCTION

(71) Applicant: Broadcom Corporation, Irvine, CA (US)

(72) Inventors: Ozgur Ekici, San Diego, CA (US); Muhammad Waseem, San Diego, CA (US)

(21) Appl. No.: 13/909,912

(22) Filed: Jun. 4, 2013

Related U.S. Application Data
(60) Provisional application No. 61/825,916, filed on May 21, 2013.

(51) Int. Cl. H04W 76/06

(52) U.S. Cl. CPC H04W 76/06
USPC 455/450

(57) ABSTRACT

Systems and methods are provided that may reduce the battery consumption footprint of a user equipment (UE) in a communications network, such as an LTE network, as well as reduce over the air signaling over the LTE network, and reduce call set-up latency for circuit switched fallback (CSFB) calls. When Idle Mode Signaling Reduction (ISR) is active in the communications network, and when the coverage area of the communications network, such as the LTE network, overlaps with the coverage area of one or more legacy radio access technology (RAT) networks, such as 2G and 3G networks, a module within the UE allows the UE to directly establish a CSFB call over one of the legacy RAT networks instead of initially servicing the CSFB call over the LTE network.

### TECHNICAL FIELD

The technical field of the present disclosure relates to wireless communications, and in particular, to exploiting the IDLE Mode Signaling Reduction (ISR) feature of the 3^{rd} Generation Partnership Project (3GPP) Long Term Evolution (LTE) standard in the context of circuit switched fallback (CSFB) connection establishment.

### BACKGROUND

User equipment (UE), e.g., a cellular telephone operating in a wireless communications network, may have various modes of operation that can include an idle mode and a connected mode. In the idle mode, the UE may power down one or more of its operating components/elements for varying periods of time. Powering down one or more of its components assists in conserving battery power (especially as the trend continues to create smaller and smaller electronic devices), as less resources need to be supplied with power. The UE may wake up periodically to monitor paging messages applicable to that UE in case the UE must engage in some activity. Such paging messages may alert the UE to the presence of, e.g., incoming calls, and/or may provide other information. In the connected mode, the UE may actively exchange data with one or more network elements to effectuate, e.g., a voice call or a data call, etc.

A mechanism utilized to control how/when the UE powers down/wakes up may be referred to as discontinuous reception (DRX). That is, the UE may periodically monitor paging messages in accordance with a DRX cycle. The DRX cycle may indicate when the UE should wake up to monitor paging messages (when the UE is in Radio Resource Control (RRC) idle mode, i.e., when the RRC connection is released), and when the UE may power down one or more elements/components to conserve battery life.

Idle mode Signaling Reduction (ISR) refers to a mechanism in LTE that allows the UE to remain simultaneously registered in a Universal Terrestrial Radio Access Network (UTRAN)/Global System for Mobile Communications (GSM) Enhanced Data rates for GSM Evolution (EDGE) Radio Access Network (GERAN) Routing Area (RA) and an Evolved UTRAN (E-UTRAN) Tracking Area (TA) list. This can allow the UE to make cell reselections between E-UTRAN and UTRAN/GERAN without the need to send any TA update (TAU) (LTE) or RA update (RAU) (2G/3G) request, as long as the UE remains within those TAs and RAs that are in the registered RA and TA list. Consequently, ISR is a feature that can reduce mobility signaling and improve the battery life of UEs.

Circuit switched fallback (CSFB) refers to another feature in LTE that enables global voice roaming and interworking for LTE devices. LTE has been designed to provide all services using/over Internet Protocol (IP), without the use of circuit switched domain functions, where services like voice communication (traditionally provided over the circuit switched domain) will eventually be replaced by, e.g., voice over IP services, such as VoLTE, and will require an IP Multimedia Subsystem (IMS). However, due to possible delays in implementing VoLTE and IMS, the 3GPP has provided a UE the ability to “fall back” to circuit switched voice calls using, e.g., existing legacy radio access technology (RAT), such as 3G circuit switched domain functions.

### BRIEF DESCRIPTION OF THE DRAWINGS

For a more complete understanding of example embodiments of the present invention, reference is now made to the following descriptions taken in connection with the accompanying drawings in which:

FIG. 1 illustrates an example communications network 100 in which various methods and apparatuses may be utilized in accordance with various embodiments;

FIG. 2 illustrates example DRX cycle length periods that may be utilized in the communications network of FIG. 1;

FIG. 3 illustrates an example message flow indicative of paging and data transfer while LTE ISR is active in the communications network of FIG. 1;

FIG. 4 illustrates an example message flow indicative of conventional CSFB call establishment in the communications network of FIG. 1;

FIG. 5 illustrates an example message flow indicative of CSFB call establishment in the communications network of FIG. 1 in accordance with various embodiments;

FIG. 6 illustrates example processes performed for establishing a CSFB call in accordance with various embodiments;

FIG. 7 illustrates an example communications device in which CSFB call establishment can be implemented in accordance with various embodiments; and

FIG. 8 illustrates example processes performed by a computer program product for establishing a CSFB call in accordance with various embodiments.

### DETAILED DESCRIPTION

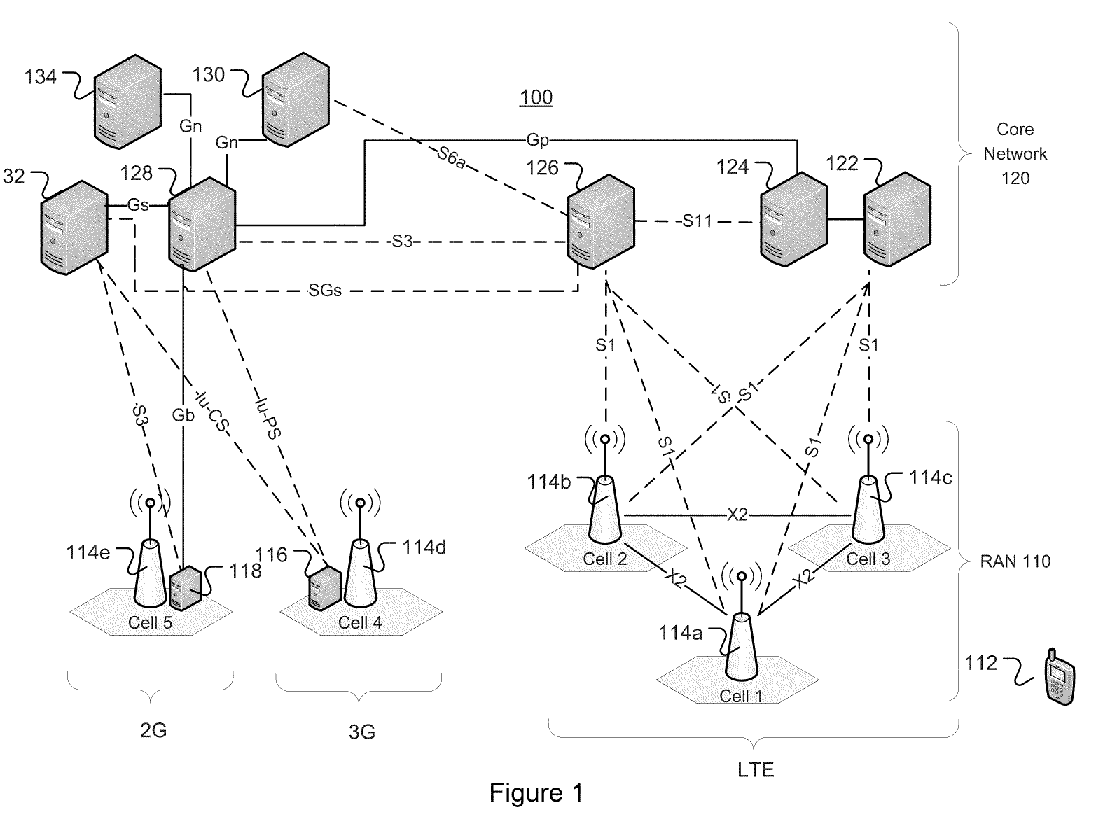

FIG. 1 illustrates an example communications network 100 in which various methods and apparatuses may be utilized in accordance with various embodiments. Communications network 100 may be a network capable of handling a variety of different RATs, such as E-UTRAN (which may also be referred to/used interchangeably herein as LTE), UTRAN (which may also be referred to/used interchangeably herein as 3G), and 2G (which may also be referred to/used interchangeably herein as 2G) communications, for example, and may include a radio area network (RAN) 110 and a core network 120. The RAN 110 may support radio communications for UEs (such as UE 112) within its coverage area. The RAN 110 may be referred to as an E-UTRAN, as it may employ evolved universal mobile telecommunications system (UMTS) terrestrial radio access (E-UTRA) radio technology to communicate with one or more UEs over an air interface. The RAN 110 may also be in communication with the core network 120, where the core network 120 may support various services for the UE 112.

The RAN 110 may include one or more evolved Node Bs (eNBs), which may also be referred to as base stations, Node B's, access points, etc. FIG. 1 illustrates the RAN 110 as including eNBs 114a, 114b, and 114c. It should be noted that the RAN 110 may include any number of eNBs in accordance with various embodiments. The eNBs 114a, 114b, 114c may each include one or more transceivers for communicating with the UE 112 over the aforementioned air interface.

Each of the eNBs 114a, 114b, 114c may be associated with one or more cells (e.g., Cell 1, Cell 2, and Cell 3, respectively), and may be configured to handle radio resource management decisions, handover decisions/mobility management, scheduling of users in the uplink (UL) and/or downlink (DL), etc. Communication between the eNBs 114a, 114b, and 114c may occur over an X2 interface.

The core network 120 may include various network entities, and may separate user plane and control plane traffic. In this example architecture, the core network 120, which may be referred to as an evolved packet core (EPC), can include control and user plane entities. A control plane entity referred to as a Mobility Management Entity (MME) may handle control plane traffic, while user plane traffic may be handled by user plane entities referred to as a Serving Gateway (SGW) and a Packet Data Network (PDN) Gateway (PDN GW or PGW).

The core network 120 may facilitate communications with other networks. For example, the core network 120 may provide access (for the UE 112) to circuit-switched networks, such as the Public Switched Telephone Network (PSTN). The core network 120 may also facilitate communications between the UE 112 and landline communications devices. For example, the core network 120 may include, or may communicate with, an Internet Protocol (IP) gateway, (e.g., an IP multimedia subsystem (IMS) server), that serves as an interface between the core network 120 and the PSTN. In addition, the core network 120 may provide the UE 112 with access to other networks, which may include other wired or wireless networks that are owned and/or operated by other service providers.

For simplicity, a single SGW 122, a single PGW 124, and one MME 126 are illustrated as being included in the core network 120. The SGW 122 may support data services such as packet data, Voice-over-Internet Protocol (VoIP) communications, video, messaging, etc., and may be connected to each of the eNBs 114a, 114b, and 114c in the RAN 110 via 51 interfaces. The SGW 122 may generally route and forward user data packets to/from the UE 112. The SGW 122 may also perform other functions, such as anchoring user planes during inter-eNB handovers, triggering paging when DL data is available for the UE 112, managing and storing contexts of the UE 112, etc.

A PGW (e.g., PGW 124) may be the interface between the LTE “subsystem” and IP networks, which may include, but are not limited to, the public Internet, and Internet Protocol Multimedia Subsystem (IMS) services that may be deployed within an operator core network.

An MME (e.g., MME 126) may be responsible for mobility management and path switching between eNBs at handover. The MME 126 may also perform paging for the core network 120. That is, and as illustrated in FIG. 1, the MME 126 may be connected to each of the eNBs 114a, 114b, and 114c in the RAN 110 via 51 interfaces, and may act as, alluded to above, a control node, while being connected to the PGW 124 via, e.g., an S11 interface. For example, the MME 126 may be responsible for authenticating users of the UE 112, bearer activation/deactivation, selecting a particular SGW during an initial attach procedure of the UE 112, etc. The MME 126 may also provide a control plane function for switching between the RAN 110 and other RANs (not shown) that employ other radio technologies, such as the Global System for Mobile Communications (GSM) standard or the Wideband Code Division Multiple Access (WCDMA) standard. The SGW 122 may be connected to the PGW 124, which may provide the UE 112 with access to packet-switched networks, such as the aforementioned public Internet, to facilitate communications between the UE 112 and other IP-enabled devices.

While each of the foregoing elements are depicted as part of the core network 120, it will be appreciated that any one of these elements may be owned and/or operated by an entity other than the core network operator. Additionally, and in accordance with other embodiments, a pool of MMEs, a pool of PGWs, and a pool of SGWs may make up the core network 120, where an S1-flex mechanism may allow an eNB, such as eNBs 114a, 114b, and/or 114c to connect to the MME, PGW, and SGW pools for load balancing purposes.

It should be noted that the SGW 122, the PGW 124, and/or the MME 126 may communicate with other entities, e.g., remote servers and terminals (not shown). Additionally, other wireless networks may include equivalent network entities. For example, a UTRAN supporting Wireless Code Division Multiple Access (WCDMA)/3G may include the aforementioned node Bs (instead of eNBs) coupled to Radio Network Controllers (RNCs). That is, and in accordance with the 3G standard, a serving general packet radio service (GPRS) support node (SGSN) 128 may be connected to the MME 126 via an S3 interface, and connected to the PGW 124 via a Grp interface. Node B 114d may operate in conjunction with RNC 116, which may be operatively connected to the SGSN 128 via an Iu-PS interface. Similarly, a base transceiver station (BTS) 114e working in conjunction with a base station controller (BSC) 118, which may be connected to the SGSN 128 via a Gb interface, can be used to provide 2G service.

A core network for, e.g., UMTS may include Mobile Switching Centers (MSCs), SGSNs, and Gateway GPRS Support Nodes (GGSNs) (instead of SGWs and MMEs). Therefore, the network 100 can support inter-radio access technology (inter-RAT)/multiple RAT communications, mobility, etc. For example, an MSC 132 may handle the routing/switching/handoff of calls, as well as controlling cells, and can be connected as follows: to RNC 116 via an Iu-CS interface; to BSC 118 via an S3 interface; to MME 126 via an SGs interface; and to SGSN 128 via a Gs interface. Additionally, GGSN 134 (responsible for internetworking between GPRS and external packet switched networks) can be connected to the SGSN 128 via a Gn interface.

A home subscriber server (HSS) 130 can be a central database that contains user-related and subscription-related information. The functions of the HSS 130 can include functionalities such as mobility management, call and session establishment support, user authentication and access authorization. Accordingly, the HSS 130 can connect to the SGSN 128 via a Gb interface, and to the MME via an S6a interface.

The UE 112 may communicate with one or more of the eNBs/Node Bs/BTSs 114a-114d, as well as with the SGSN 128, the MME 126, and the SGW 122. The UE 112 may communicate with network entities (e.g., the eNBs 114a, 114b, and 114c) in the RAN 110 via lower layer signaling, and may communicate with network entities (e.g., the MME 126 and the SGW 122) in the core network 120 via upper layer signaling, e.g., Non Access Stratum (NAS) signaling in UMTS/3G and LTE. The UE 112 may also be referred to as a mobile station, a terminal, an access terminal, a subscriber unit, a station, etc., and the UE 112 may be, e.g., a cellular phone, as described above, a personal digital assistant (PDA), a wireless modem, a wireless communication device, a handheld device, a laptop computer, a cordless phone, a wireless local loop (WLL) station, etc. The eNBs 114a, 114b, and 114c may broadcast system information (SI) via a broadcast channel to provide information within various SI types, each of which provides information required by UEs, (e.g., network information (mobile country code (MCC)/mobile network code (MNC) of a network), frequency synchronization parameters, and the like). SI may include the aforementioned NAS and Access Stratum (AS) SI.

In conjunction with ISR, DRX may be used in mobile communications to conserve the battery life of a UE, such as the UE 112, where during certain periods/time intervals (in an active/awake mode), data transfer may occur, and during other periods/time intervals, the UE 112 may turn its receiver off to enter into a low power state. A DRX cycle may be negotiated by the communications network 100 or sent/defined by the UE 112. In particular, and in accordance with UMTS and LTE standards, the UE 112 may indicate a DRX cycle length to the core network 120 via NAS signaling, e.g., during an attach procedure or a TAU procedure. This DRX cycle length may be specific to the UE 112, and the UE 112 may change the DRX cycle length depending on a particular service being received by the UE 112, a particular device type of the UE 112, and/or other factors. It should be noted that DRX cycle length in the context of various embodiments disclosed herein may refer to “idle mode” DRX cycle length, rather than “connected mode” DRX parameters, such as, e.g., short or long DRX cycle lengths.”

The communications network 100 (e.g., MME 126, and ultimately, a relevant eNB, e.g., eNB 114a, 114b, or 114c) may send paging messages to the UE 112 in accordance with time intervals determined by the DRX cycle. These paging messages may alert the UE 112 to, e.g., incoming calls and/or may be used for other purposes. Alternatively, the communications network 100 may send the DRX cycle(s) over a broadcast channel by defining new SI block (SIB) information.

In particular, the DL Paging Control Channel (PCCH) is used to transmit paging information to UEs, where UEs may be notified of changes in SI, which may, e.g., require a reacquisition of SI. A UE uses DRX in idle mode to reduce battery consumption, as previously described, where a DRX cycle may be configured by certain parameters sent in an SI Block 2 (SIB2). The UE may monitor the PDCCH at certain intervals (set by the DRX cycle parameters) in order to check for the presence of a paging message. That is, the UE utilizes the DRX cycle during idle mode to wake itself up to check for such paging messages. If the PDCCH indicates that a paging message is being transmitted in a subframe, the UE may decode the Physical Downlink Shared Channel (PDSCH) to see if the paging message is directed to that UE. Paging messages may be sent to all eNBs within a TA.

In accordance with the standard(s) specifying paging procedures in the 51 protocol, the MME 126 may initiate a paging procedure by sending a paging message to an applicable eNB, e.g., eNB 114a, 114b, or 114c. Upon receiving the paging message from the MME 126, the relevant eNB (e.g., eNB 114a, 114b, or 114c) may perform paging of the relevant UE in the cell(s) which belong to TAs indicated in the (aforementioned) list of TAs information element (IE) (e.g., the UE 112 in one of more of the Cells 1, 2, and/or 3). For each of the cells (e.g., Cells 1, 2, and/or 3) that belong to any of the TAs indicated in the list of TAs IE, the relevant eNB (e.g., eNB 114a, 114b, or 114c) may generate a page on the radio interface. This paging procedure occurs in accordance with the DRX cycle.

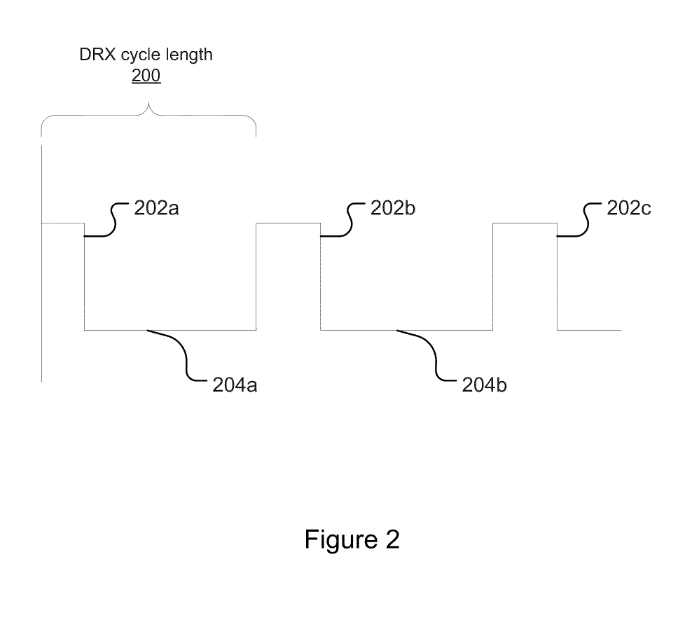

FIG. 2 illustrates an example representation of a DRX cycle length 200 broadcast by an eNB, e.g., eNB 114a. With respect to the DRX cycle length 200, an active/awake mode or duration may be indicated by periods 202a, 202b, and 202c. During these periods, the UE 112 may monitor the PDCCH for paging messages. Idle modes or durations may be indicated by periods 204a and 204b. It is during these idle mode periods 204a and 204b that DRX is utilized, e.g., the receiver of the UE 112 may be turned off. The DRX cycle length 200 includes one active/awake mode period and one idle mode period.

ISR is a feature that allows wireless devices, e.g., UEs, to move between LTE and 2G/3G technologies/networks without performing TAU or RAU procedures once the ISR feature has been activated. As alluded to previously, ISR may be used to limit the signaling between the UE and a network (i.e., the registration procedure) as well as signaling within the network. However, and because the UE does not have to perform registration (i.e., TAU and RAU procedures) while moving back and forth between LTE and 2G/3G networks/RATs, the network remains unaware as to which RAT the UE is camped on at any given time. Therefore, and in order to reach the UE for, e.g., a mobile terminated (MT) call, the network may be forced to page the UE on both LTE and 2G/3G registration areas (i.e., in TAU and RAU order). Accordingly, the cost of utilizing the ISR feature is more complex paging procedures for UEs in ISR, which need to be paged on both the registered RA and all registered TAs, and a HSS may further need to maintain two packet switched (PS) registrations (one from an MME, and another from an SGSN).

Referring back to FIG. 1, and as previously alluded to, a TA can refer to an area in which LTE service can be provided, and may include one or more LTE cells, e.g., cells 1, 2, and 3. An RA can refer to an area in which 2G/3G service can be provided, and in the example communications network 100, may include cells 4 and 5. A TA list can indicate a list of TAs that a UE can enter without performing a TAU procedure, while an RA list can indicate a list of RAs that a UE can enter without performing a RAU procedure.

“Camping on” a cell can refer to an action/state where a UE has completed a cell selection/reselection process and has chosen a cell for which SI and paging information can be monitored. When a UE camps on an E-UTRAN cell, for example, the UE can perform location registration on the MME, and if the UE moves to and camps on a UTRAN/GERAN cell, the UE can perform location registration on the SGSN. Accordingly, and as the UE frequently moves between the E-UTRAN and the UTRAN/GERAN networks/TAs and RAs, the ISR mechanism allows for the UE to respectively perform location registration on the MME and the SGSN (two mobility management nodes) via the E-UTRAN and the UTRAN/GERAN once.

When in idle mode, the UE does not need to perform additional location registration when moving between two pre-registered Radio Access Technologies (RATs), or when reselecting a cell. If there is downlink (DL) data that should be sent to a corresponding UE in an ISR activated state and in idle mode, paging can be simultaneously delivered to the E-UTRAN and the UTRAN/GERAN. This allows the network to successfully search for the UE and to deliver the DL data to the UE.

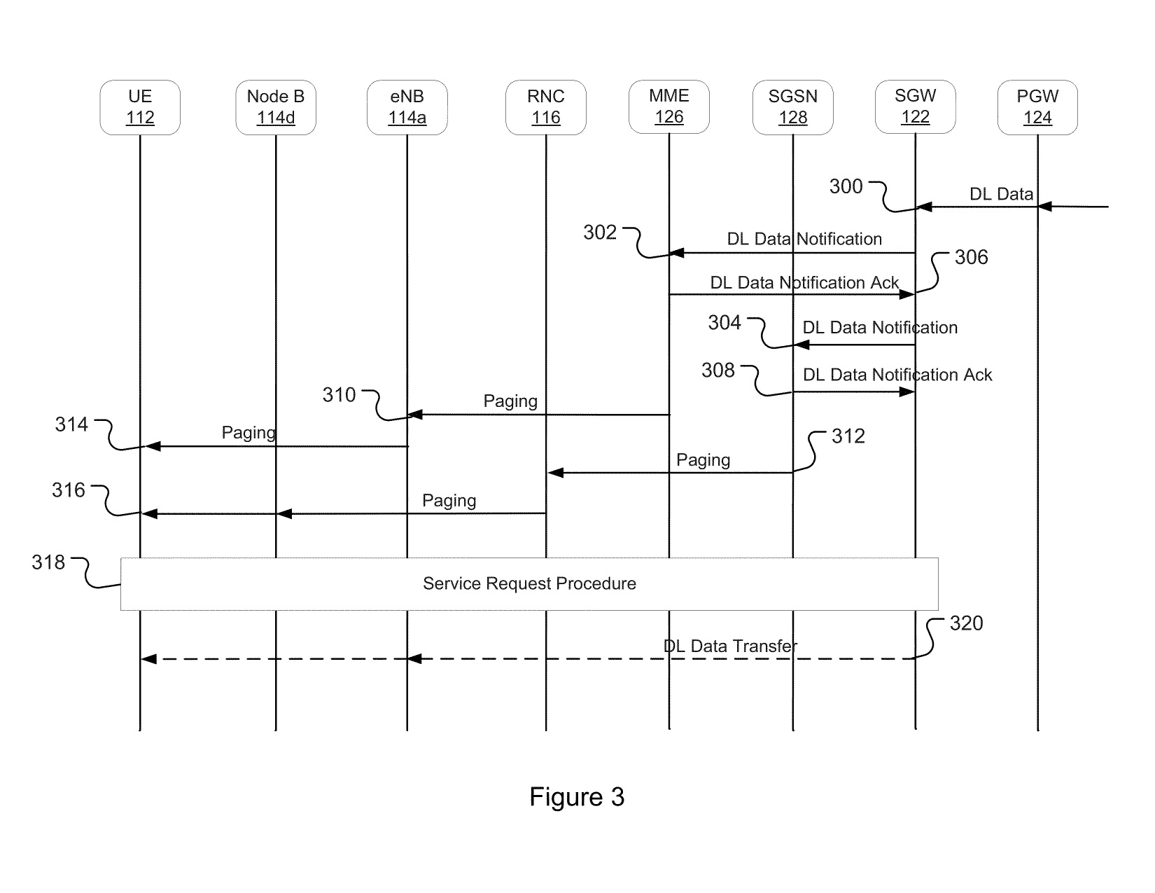

FIG. 3 illustrates an example message flow diagram indicative of paging under ISR when a UE is in idle mode (and camped on an E-UTRAN cell). A PGW, e.g., PGW 124, may receive DL data intended to be transmitted to a UE, e.g., UE 112, by way of an SGW, e.g., SGW 122 at 300. The DL data may be buffered by the SGW 122, while the SGW 122 identifies the appropriate MME serving the UE 112, e.g., MME 126 (as well as determined whether the ISR feature is activate for the UE 112. As described above, the network may be unaware as to whether the UE 112 is camped on a E-UTRAN cell (e.g., cell 1/eNB 114a) or a UTRAN/GERAN cell (e.g., cell 4, Node B 114d), and accordingly, the SGW 122 further determines what SGSN may be serving the UE 112, in this example, SGSN 128. The SGW 122 may then request each of the MME 126 and SGSN 128 to page the UE 112. In particular, a DL data notification message can be sent to the MME 126 and SGSN 128 at 302 and 304, respectively. The MME 126 and the SGSN 128 may respond to the DL data notification message with a DL data notification acknowledgement message transmitted to the SGW 122 at 306 and 308, respectively.

The MME 126 and the SGSN 128 can send a paging message to the UE 112 through each serving access network. In particular, the MME 126 can send a paging message at 310 to each eNB (e.g., eNB 114a) included in the TAs on which the UE 112 has registered, while the SGSN 128 can send a paging message at 312 to the RNC/BSC (e.g., 116). Each eNB that receives the paging message from the MME 126 (e.g., eNB 114a) may page the UE 112 at 314, and the RNC/BSC that received the paging message from the SGSN 128 (e.g., RNC 116) may page the UE 112 at 316.

As described above, it may be assumed for purposes of this example that the UE 112 is camped on an E-UTRAN cell, e.g., eNB 114a. Accordingly, the UE 112 can respond to the paging received from the MME 126 via the E-UTRAN, and can initiate a Service Request Procedure, thereby setting up a user plane as a path at 318. The SGW 122 may then transfer the DL data intended for the UE 112 to the UE 112 at 320. Alternatively, and if the UE 112 is camped on a UTRAN/GERAN cell, e.g., cell 4/Node B 114d, rather than the E-UTRAN cell, the UE 112 can respond to paging received via the UTRAN/GERAN (by way of the SGSN 128 and the RNC 116), and if a user plane is set in the Service Request Procedure, the DL data transfer can occur to the UE 112 from the SGW 122.

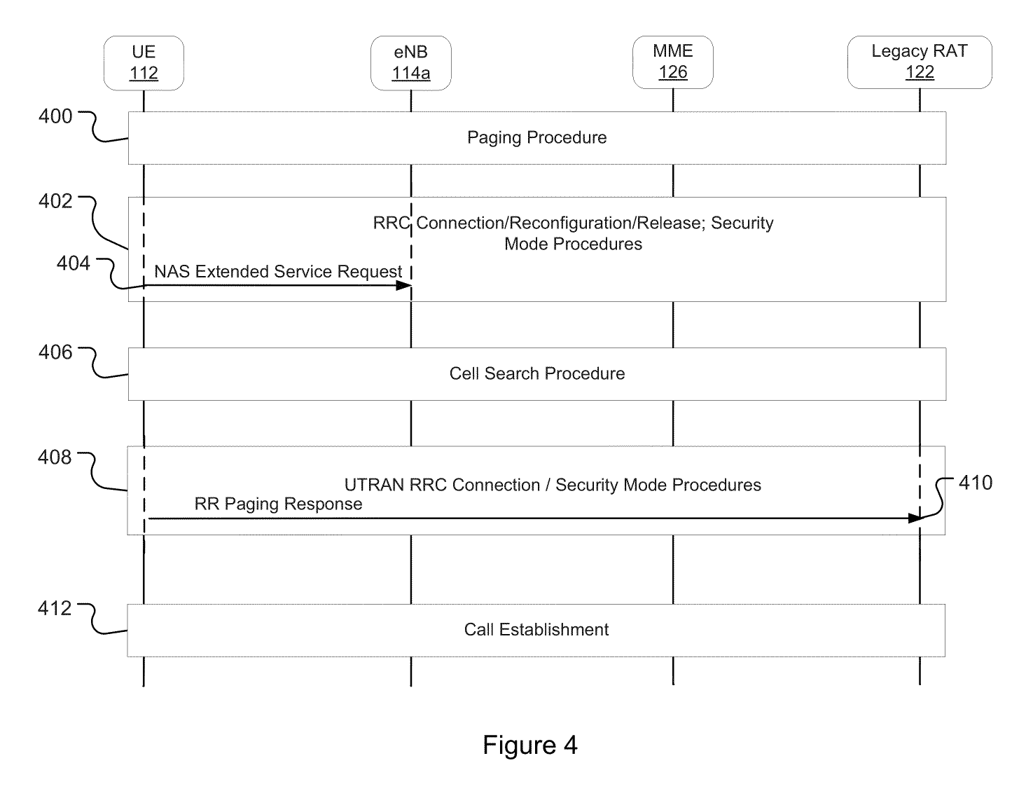

For CSFB, paging, as described above in the context of ISR, can be performed for the purpose of establishing a voice call, rather than for data transfer. FIG. 4 illustrates an example, conventional message flow indicative of procedures/signaling performed for CSFB call establishment. As in FIG. 3, it can be assumed that a UE, e.g., UE 112, is in idle mode and camped on an E-UTRAN cell, e.g., cell 1/eNB 114a. Accordingly, and to establish a voice call, a paging procedure is performed at 400, similar to that described above in FIG. 3. If the voice call to be established is a mobile terminated call, MME 126 can send a paging message to UE 112, where the paging message can indicate to UE 112, that the call to be established is a CSFB/voice call. That is, the aforementioned DL PCCH can be used to transmit paging information to UEs, where the paging message can indicate that it originates from a CS core network, e.g., a core network domain indicator in an IE indicates a CS domain (IE cn-Domain: cs). In response to the paging message, UE 112 may send an NAS Extended Service Request message to MME 126 with a CSFB indication at 404. If the voice call to be established is a mobile originated call, and while UE 112 is camped on, e.g., cell 1/eNB 114a, the UE may simply send the NAS Extended Service Request message to MME 126 with the CSFB indication, instead of responding to a paging message.

Various RRC Connection/Release and Security Mode procedures can be performed at 402. That is, and in order to send the NAS Extended Service Request message to MME 126, UE 112 can establish an RRC connection, where establishing the RRC connect can include UE 112 sending an RRC Connection Request to eNB 114a, and receiving an RRC Connection Setup message from eNB 114a in response. The NAS Extended Service Request message can be sent within an RRC Connection Setup Complete message to eNB 114a. Moreover, UE 112 can be instructed by eNB 114a to activate security measures via a Security Mode Command in order to protect the integrity of RRC signaling. Upon completion of the security measures, UE 112 can send a Security Mode Complete message, and an RRC Connection Reconfiguration procedure can commence for configuring, e.g., measurement events and establishing data radio bearers. Further still, eNB 114a may send an RRC Connection Release message to UE 112, the RRC Connection Release message containing, information regarding a carrier frequency on which the UE 112 should search for an appropriate cell to camp on/utilize for the voice call. Thereafter, UE 112 may release the RRC Connection (in LIE).

After receipt of the information regarding where to search for an appropriate or preferred cell, UE 112 may commence a cell search procedure at 406. That is, UE 112 can tune its radio to the target legacy RAT network (GERAN/UTRAN). If the target legacy RAT network is a UTRAN, UE 112 can search for all of the UTRAN Broadcast Control Channel (BCCH) carrier frequencies provided in the RRC Connection Release message (in LTE). In order to access a selected UTRAN cell, e.g., cell 4/Node B 114d, UE 112 must initially access/obtain that selected cell's system information. This can include UE 112 receiving information broadcast on the BCCH (in a System Information Container that can include, e.g., Master Information Block (MIR) information which can include, e.g., Mobile Country Code and Network Code information, as well as, e.g., SIB 1, SIB3, SIB5, and SIB7 information).

After UE 112 has determined an appropriate cell to camp on, and UE 112 camps on that cell, e.g., cell 4/Node B 114d, UE 112 can establish an RRC connection in UTRAN (or channel assignment in GERAN), as well as engage in any necessary security measures at 408, similar to that described above with regard to the E-UTRAN/LTE system. This can include, e.g., sending an RRC Connection Request message to Node B 114d, receiving an RRC Connection Setup message from Node B 114d, and responding with an RRC Connection Setup Complete message. UE 112 may also respond with an RR Paging Response message at 410 (as if it was camped on the UTRAN cell in the first place), and exchange Direct Transfer (Initial Direct Transfer and Downlink Direct Transfer) messages with RNC 116/MSC 132 that can contain routing information to be used in establishing a signaling connection to the UTRAN core network. Ultimately, call establishment can occur at 412.

Regarding cell selection/re-selection during idle mode, a UE may maintain the two registrations (E-UTRAN and UTRAN/GERAN) and run timers for the two registrations. Furthermore, the UE can store MM parameters from the SGSN (e.g., P-TMSI and RA) and the MME (e.g., GUTI and TA(s)), as well as session management (bearer) contexts common to E-UTRAN and UTRAN/GERAN. In idle mode, the UE may reselect between E-UTRAN and UTRAN/GERAN within the registered RA and TAs (without performing TAU and RAU procedures as previously described), while the SGSN and MME store each other's respective address when ISR is activated.

That is, and when a UE is initially switched on, a public land mobile network (PLMN) may be selected by NAS, and for the selected PLMN, an associated RAT may be set. With cell selection, the UE can search for a suitable cell of the selected PLMN, choose that cell to provide available services, and further shall tune to the cell's control channel, i.e., the aforementioned “camping on the cell.” The UE may, if necessary, register its presence, by way of a NAS registration procedure, in the TA of the chosen cell. If the UE finds a more suitable cell, according to cell reselection criteria, the UE may reselect onto that more suitable cell, and camp on it. If the new cell does not belong to at least one TA to which the UE is registered, location registration is performed. If necessary, the UE may search for higher priority PLMNs at regular time intervals, and search for a suitable cell if another PLMN has been selected by NAS, while a search for available closed subscriber groups (CSGs) may be triggered by NAS to support manual CSG selection. If the UE loses coverage of the registered PLMN, either a new PLMN may be selected automatically (automatic mode), or an indication of which PLMNs are available is given to a user, so that a manual selection can be made (manual mode).

To effectuate cell selection and reselection, the UE can perform various measurements upon which cell selection and reselection may be based, where the NAS can control the RAT(s) in which the cell selection should be performed, for instance by indicating RAT(s) associated with the selected PLMN, and by maintaining a list of forbidden registration area(s) and a list of equivalent PLMNs. The UE can then select a suitable cell based on idle mode measurements and cell selection criteria. In order to speed up the cell selection process, stored information for several RATs may be available in the UE. When camped on a cell, the UE may regularly search for a better cell according to the cell reselection criteria. If a better cell is found, that cell is selected. The change of cell may imply a change of RAT.

For normal service, the UE may camp on a suitable cell, tune to that cell's control channel(s) so that the UE can, e.g., receive system information from the PLMN; receive registration area information from the PLMN, e.g., TA information; receive other AS and NAS Information; and if registered: receive paging and notification messages from the PLMN; and initiate transfer to connected mode. The various rules, states, measurements, criteria, etc. upon which cell selection and reselection can be based may include, but are not limited to, for example, cell ranking in a hierarchical cell structure architecture, cell priority, quality level threshold criterion, cell selection RX levels, maximum TX power level a UE may use when accessing a cell, etc.

It should be noted that the same or similar processes may be performed in the UTRAN/GERAN context as specified in the respective standards that specify UE procedures in idle mode.

That is, and in accordance with conventional implementations of CSFB, a UE is required to establish the CSFB call on the LTE network first, and wait for the LTE network to redirect the UE back to GSM/UMTS RAT to re-establish the CS call. However, with the ISR feature active, for, e.g., mobile terminated voice calls, the LTE network pages a UE in both the LTE and GSM/UMTS RATs, and can expect call connection establishment either on the LTE network or on a legacy RAT (e.g., GERAN/UTRAN). That is, and as described above, the UE can keep the two registrations (LTE and GSM/UMTS) in parallel. Similarly, the network can keep both registrations of a single UE (GSM/UMTS and LTE registrations) in parallel, while also ensuring that the UE can be paged in both the RA of the GERAN/UTRAN and the TA of the LTE network the UE is registered in. Thus, for a given mobile terminated call, the network has to page the UE in both the LTE TA and the GERAN/UTRAN RA. This “double-paging” requirement of ISR can give the UE the flexibility to respond to a paging message for a voice call that is received on LTE network, on GSM/UMTS RAT. Therefore, and in accordance with various embodiments, in a communication environment where a CSFB call (i.e., voice call) is initiated on an LTE network with the ISR feature activated, the UE can establish the CS (i.e. voice) call directly on a GSM/UMTS RAT.

In other words, various embodiments can combine/leverage the requirements of CSFB implementation with the benefits of ISR for more efficient operation. For a mobile terminated CSFB call in an LTE network, the UE is aware that the CSFB call request received on an LTE network will eventually be redirected to a GERAN/UTRAN (as described above via an IE in the PCCH paging message received by the UE). Hence, and by detecting that ISR is active on a network, a UE can intelligently respond to the paging message (received over the LTE network) using GSM/UMTS RAT instead, to avoid further latency and redundant channel establishment on the LTE network. For a mobile originated CSFB call in an LTE network, the UE knows that the CSFB call is intended to be serviced by a GSM/UMTS RAT. That is, and as previously described, while the UE is camped on an E-UTRAN cell, the UE may simply send a Service Request message for a mobile originated CS call directly to GSM/UMTS RAT, rather than engaging in a CSFB call on LTE via a NAS Extended Service Request message transmission. Again, the UE is aware of/can determine or detect the intent to service a CSFB call over a GSM/UMTS RAT, and can directly establish the CS call over a GERAN/UTRAN, thereby negating the need to involve the LTE RAT.

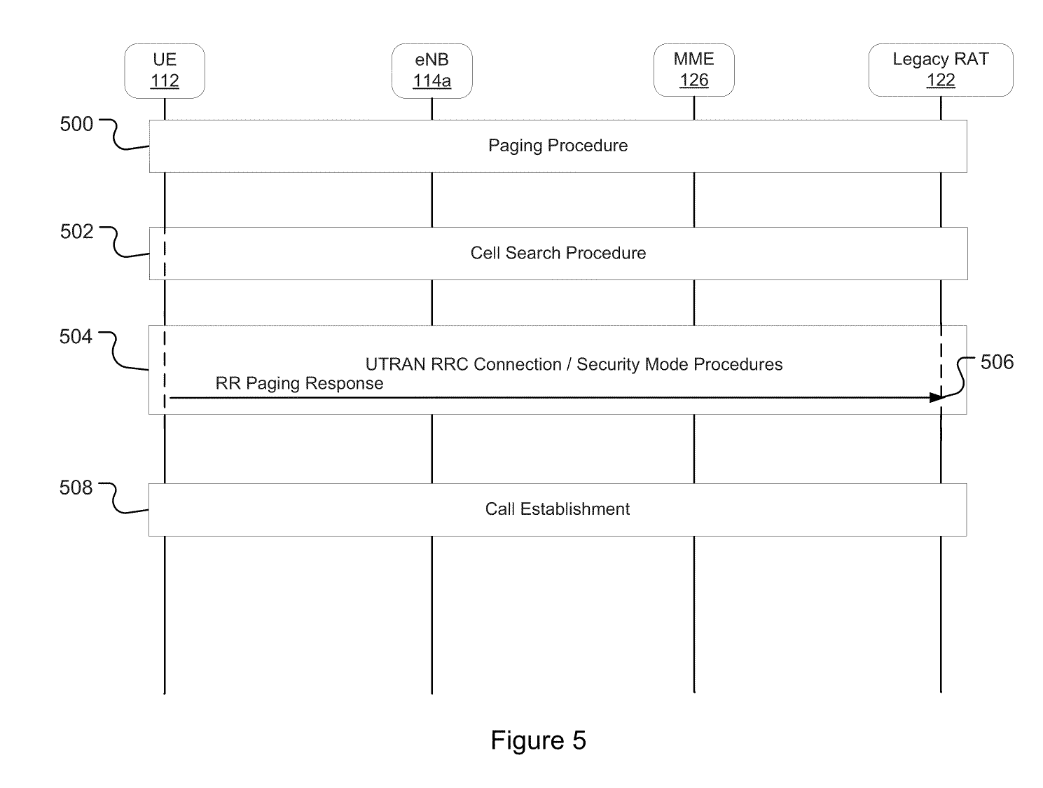

Accordingly, and in contrast to conventional CSFB call establishment, FIG. 5 illustrates an example message flow indicative of procedures/signaling performed for CSFB call establishment in accordance with various embodiments. As in FIG. 4, it can again be assumed that a UE, e.g., UE 112, is in idle mode and camped on an E-UTRAN cell, e.g., cell 1/eNB 114a. Accordingly, and to establish a voice call, a paging procedure is performed at 500, similar to that described above in FIG. 4. If the voice call to be established is a mobile terminated call, MME 126 can send a paging message to UE 112, where the paging message can indicate to UE 112, that the call to be established is a CSFB/voice call. That is, the aforementioned DL PCCH can be used to transmit paging information to UEs, where the paging message can indicate that it originates from a CS core network, for example, e.g., a core network domain indicator in an IE indicates a CS domain (IE cn-Domain: cs). However, and instead of engaging the LTE network, and because UE 112 is already aware that the call is intended to be serviced in the CS domain (i.e., by a legacy RAT), UE 112 can may commence a cell search procedure at 502. That is, UE 112 can tune its radio to the target legacy RAT (GERAN/UTRAN). If the target legacy RAT is a UTRAN system, UE 112 can search for all of the UTRAN Broadcast Control Channel (BCCH) carrier frequencies in order to access a selected UTRAN cell, e.g., cell 4/Node B 114d, UE 112 must initially access/obtain that selected cell's system information. This can include UE 112 receiving information broadcast on the BCCH (in a System Information Container that can include, e.g., Master Information Block (MIB) information which can include, e.g., Mobile Country Code and Network Code information, as well as, e.g., SIB 1, SIB3, SIB5, and SIB7 information).

After UE 112 has determined an appropriate cell to camp on, and UE 112 camps on that cell, e.g., cell 4/Node B 114d, UE 112 can establish an RRC connection in UTRAN (or channel assignment in GERAN), as well as engage in any necessary security measures at 504, similar to that described above with regard to the E-UTRAN/LTE system. This can include, e.g., sending an RRC Connection Request message to Node B 114d, receiving an RRC Connection Setup message from Node B 114d, and responding with an RRC Connection Setup Complete message. UE 112 may also respond with an RRC Paging Response message at 506, and exchange Direct Transfer (Initial Direct Transfer and Downlink Direct Transfer) messages with RNC 116/MSC 132 that can contain routing information to be used in establishing a signaling connection to the UTRAN core network. Ultimately, call establishment can occur at 508.

Again, and in accordance with conventional CSFB call establishment, when a mobile terminated voice call, for example, is initiated on an LTE network with the ISR feature activated, a target UE that is camped on an LTE cell will establish the CSFB call on the LTE network first. The LTE network will then subsequently re-direct the CSFB call to a GERAN/UTRAN in order to serve the CSFB call. Again, this is despite the UE's knowledge that the CSFB call will eventually be re-directed to a GERAN/UTRAN, because the LTE network is the “currently camped technology,” and the UE itself is paged on the LTE network.

Such behavior in a conventional CSFB implementation can cause not only increased call establishment latency, and larger battery consumption footprint; but also increased network side signaling that can potentially contribute to network congestion. Table 1 illustrates an example “summary” of CSFB call establishment signaling messages (as described above with respect to FIG. 4) on an example commercial network, where at least 8 of the initial signaling messages occur over an LIE network. Table 2 illustrates an example summary of CSFB call establishment signaling messages (as described above with respect to FIG. 5) in accordance with various embodiments, where the LIE network is bypassed.

TABLE 1

| Signaling | | | Tech- |
|---|---|---|---|
| Index | Protocol Signaling Messages | Direction | nology |
| 1 | RRC: PCCH Paging | DL | LTE |
| 2 | NAS: EMM Extended Service Request | UL | LTE |
| 3 | RRC: RRCConnectionRequest | UL | LTE |
| 4 | RRC: RRCConnectionSetup | DL | LTE |
| 5 | RRC: RRCConnectionSetupComplete | UL | LTE |
| 6 | RRC: SecurityModeCommand | DL | LTE |
| 7 | RRC: SecurityModeComplete | UL | LTE |
| 8 | RRC: RRCConnectionReconfiguration | DL | LTE |
| 9 | RRC: RRCConnectionReconfiguration- | UL | LTE |
| | Complete | | |
| 10 | RRC: RRCConnectionRelease | DL | LTE |
| 11 | RRC: MIB (System Information) | DL | UMTS |
| 12 | RRC: SIB5 (System Information) | DL | UMTS |
| 13 | RRC: SIB3 (System Information) | DL | UMTS |
| 14 | RRC: SIB1 (System Information) | DL | UMTS |
| 15 | RRC: SIB7 (System Information) | DL | UMTS |
| 16 | RRC: RRC Connection Request | UL | UMTS |
| 17 | RRC: RRC Connection Setup | DL | UMTS |
| 18 | RRC: RRC Connection Setup Complete | UL | UMTS |
| 19 | NAS: RR Paging Response | UL | UMTS |
| 20 | RRC: Initial Direct Transfer | UL | UMTS |
| 21 | RRC: Security Mode Command | DL | UMTS |
| 22 | RRC: Security Mode Complete | UL | UMTS |
| 23 | RRC: Downlink Direct Transfer | DL | UMTS |
| 24 | RRC: CC SETUP (Voice Call | DL | UMTS |
| | Establishment) | | |

TABLE 2

| Signaling | | | |
|---|---|---|---|
| Index | Protocol Signaling Messages | Direction | Technology |
| 1 | RRC: PCCH Paging | DL | LTE |
| 2 | RRC: MIB (System Information) | DL | UMTS |
| 3 | RRC: SIB5 (System Information) | DL | UMTS |
| 4 | RRC: SIB3 (System Information) | DL | UMTS |
| 5 | RRC: SIB1 (System Information) | DL | UMTS |
| 6 | RRC: SIB7 (System Information) | DL | UMTS |
| 7 | RRC: RRC Connection Request | UL | UMTS |
| 8 | RRC: RRC Connection Setup | DL | UMTS |
| 9 | RRC: RRC Connection Setup | UL | UMTS |
| | Complete | | |
| 10 | NAS: RR Paging Response | UL | UMTS |
| 11 | RRC: Initial Direct Transfer | UL | UMTS |
| 12 | RRC: Security Mode Command | DL | UMTS |
| 13 | RRC: Security Mode Complete | UL | UMTS |
| 14 | RRC: Downlink Direct Transfer | DL | UMTS |
| 15 | RRC: CC SETUP (Voice Call | DL | UMTS |
| | Establishment) | | |

Comparing the signaling messages of Table 1 with the signaling messages of Table 2, it can be seen that over the air signaling traffic may be drastically reduced when implementing CSFB call establishment in accordance with various embodiments. Furthermore, the call establishment latency can be reduced by at least 200 ms (depending on the network configuration) due to skipping/bypassing the CSFB call establishment procedure in an LTE network. Further still, the UE's battery performance will improve due to fact that the UE is not required to establish a call on two different RATs for a single CSFB (voice) call.

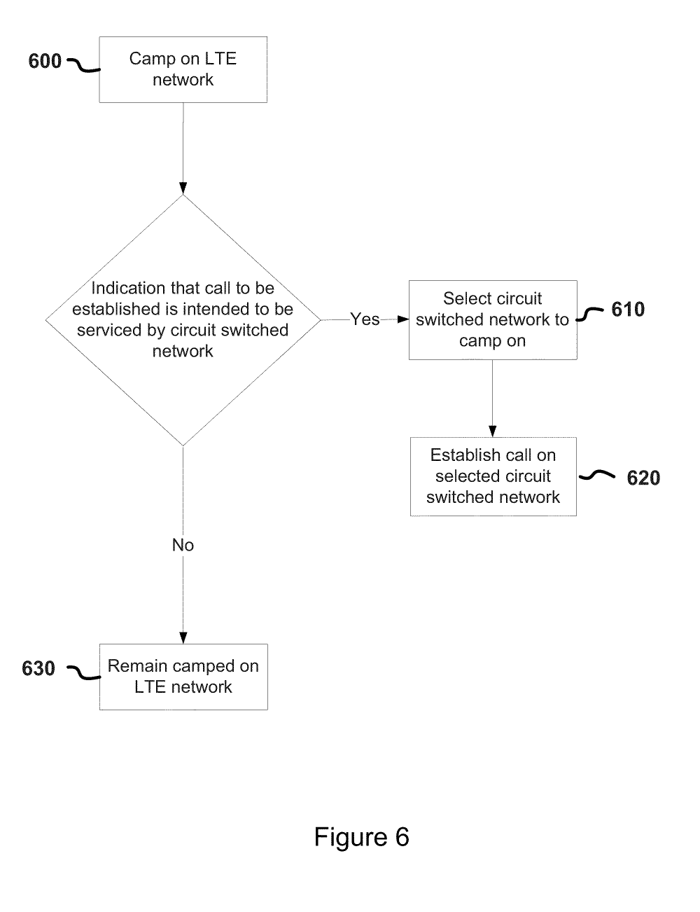

FIG. 6 illustrates example processes performed in accordance with various embodiments for CSFB call establishment in conjunction with ISR. At 600, a UE camps on an LTE network. That is, and as described above, a UE, e.g., a multi-mode UE capable of operating in an LTE as well as legacy (circuit switched) network, such as a 2G (GSM)/3G (UMTS) network, may be instructed or allowed to camp on a cell of the LTE network, where coverage areas of the LTE and 2G/3G networks overlap. In a mobile terminated call scenario, the UE may receive a paging message indicating an incoming call is a CSFB call (i.e., will be serviced by a circuit switched network). In a mobile originated call scenario, the UE can send a service request indicating the call to be established is a CSFB call (also to be serviced by a circuit switched network). If such an indication is received (e.g., a paging message, or service request message indicative of a CSFB call) a circuit switched network is selected to be camped on at 610. At 620, the call is established on the selected circuit switched network. If there is no indication received that the call to be established is a CSFB call, the UE can remain camped on the LTE network at 630.

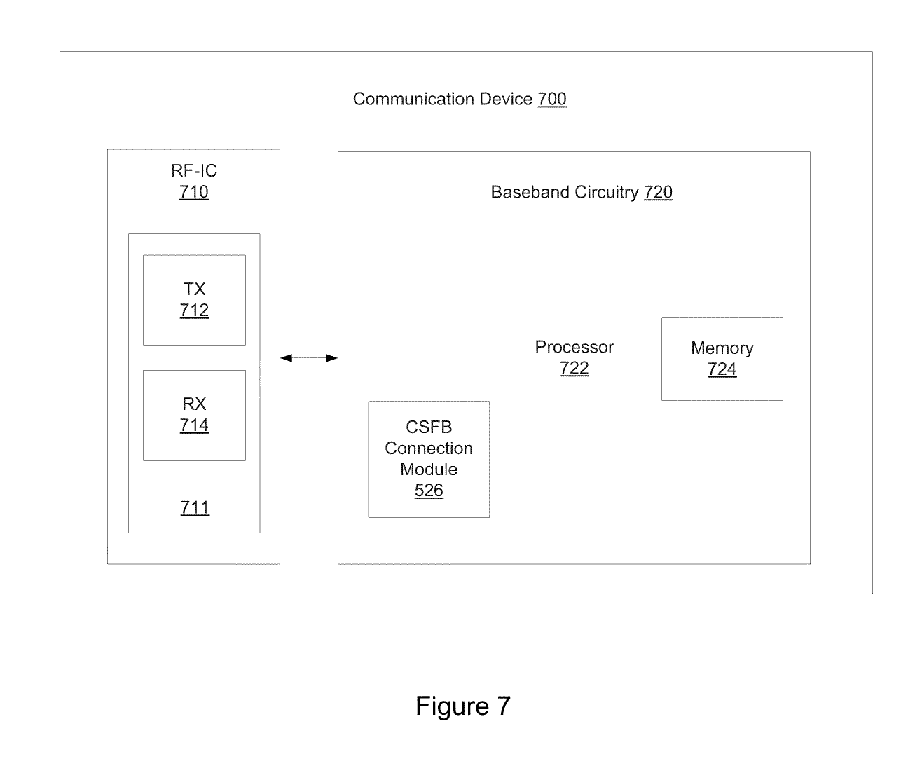

FIG. 7 is a block diagram of an example communication device 700, which may be an embodiment of the UE 112 of FIG. 1. The communication device 700 may include radio frequency (RF) circuitry 710 connected to baseband circuitry 720. The RF circuitry 710 can include a radio transceiver module 711 for transmitting and receiving RF signals and interfaces, e.g., via a duplex filter, with an RF antenna module(s) of the device, and may implemented on an integrated circuit (IC), for example. The radio transceiver module 711 can include an RF transmitter (TX) 712 that transmits signals to one or more neighboring cells in a wireless network, e.g., cells 1-5 of FIG. 1. The radio transceiver module 711 also can include an RF receiver (RX) 714 that receives signals broadcast from one or more neighboring cells, e.g., cells 1-5. The RF transmitter 712 and RF receiver 714 may include various RF components, such as amplifiers, filters, local oscillators and mixers/modulators. In operation, the RF transmitter 712 can modulate and up-convert a baseband signal from the baseband circuitry 720 onto an RF carrier generated by a local oscillator within the RF transmitter 712 for RF transmission. Further, the RF receiver 714 may filter and down-convert received RF signals into a signal to be processed by the baseband circuitry 720. The RF transmitter 712 and the RF receiver 714 may be independently turned on-and-off based on a mode of operation of the communication device 700 (e.g., in compliance with DRX and/or ISR). In some implementations, a single transceiver unit can replace the separate RF transmitter 712 and RF receiver 714, and in still other implementations, multiple transmitters, receivers, transceivers, and/or antennas may be used to support multiple RATs.

The baseband circuitry 720 may provide digital signal processing and control functions within the communication device 700, and may also be implemented on an IC. The baseband circuitry 720 can include a receive baseband module (not shown) that filters and converts the analog signal received from the RF receiver 714 into a digital signal for further processing. The baseband circuitry 720 may also include a transmit baseband module (not shown) that processes and converts a digital baseband signal into an analog signal that can be transmitted to the RF transmitter 712.

The baseband circuitry 720 can control the RF circuitry 710 to selectively turn either or both of the RF transmitter 712 and the RF receiver 714 on/off based on a mode of operation implemented by the communication device 700. In addition, either or both of the baseband circuitry 720 and the RF circuitry 710 can be turned on/off based on a mode of operation. For example, in a normal mode of operation, both the RF circuitry 710 and the baseband circuitry 720 can be turned on to establish a connection with one of the neighboring cells, e.g., to download data through the established connection and to process the downloaded data. In a DRX or ISR mode of operation, the baseband circuitry 720 can turn the RF circuitry 710 on to monitor signals (e.g., paging messages) broadcast by the one or more neighboring cells, e.g., cells 1-5. Then, the baseband circuitry 720 can turn the RF circuitry 710 off to reduce power consumption while the baseband circuitry 720 processes the received signals. In some implementations, the RF circuitry 710 can be turned on for a portion of the time when the baseband circuitry 720 is turned on to process the received signals.

To support various functions of the baseband circuitry 720, a processor 722 and memory 724 can be included to interface with and control operation of other components of the baseband circuitry 720. As an example, baseband circuitry 720 can be used to decode monitored signals received through the RF circuitry 720, e.g., to identify the single frequency network corresponding to each neighboring cell, and may be configured to support LTE, 2G, 3G, etc. standards. The decoded signals or the raw monitored signals can be stored in a memory component 724. Various types of Random Access Memory (RAM) devices, Read Only Memory (ROM) devices, Flash Memory devices, and other suitable storage media can be used to implement the memory component 724. In addition, the memory component 724 can store other information and data, such as instructions, software, values, and other data processed or referenced by the processor 722.

Various components of the baseband circuitry 720 can be selectively turned on-and-off, either as a group or individually, to efficiently use the chip resources for handling various processing tasks while reducing overall chip power consumption. The processor 722 can control various operations of the remaining components in the baseband circuitry 720, including selectively turning these components on-and-off to support a particular mode of operation.

A CSFB connection module 726 can be utilized, as described above, to control/direct the communication device 700 with regard to bypassing LTE network interaction and directly establishing a CSFB call with a circuit switched network. In particular, and while ISR is active, the CSFB connection module 726 can allow the communication device 700 to camp on a legacy RAT (circuit switched) network, such as a 2G or 3G neighboring cell to process incoming (mobile terminated) or outgoing (mobile originated) voice calls.

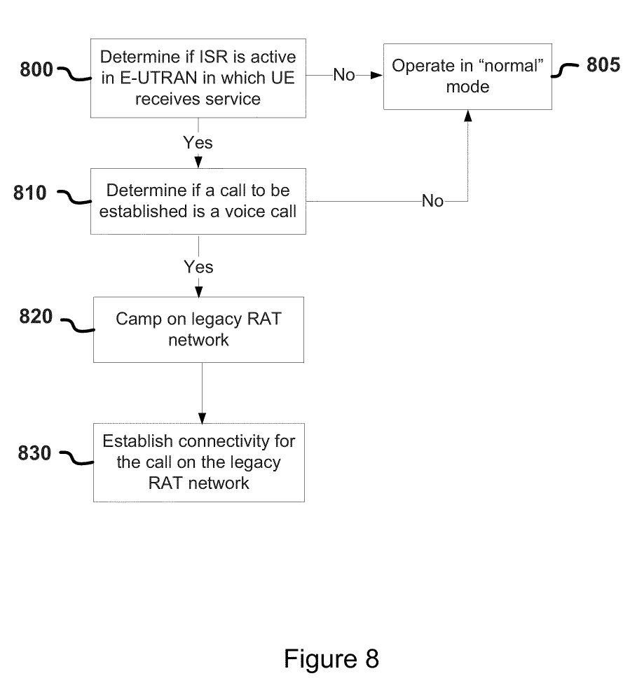

FIG. 8 illustrates example processes performed by a computer program product, embodied on a non-transitory computer-readable medium in accordance with various embodiments. As previously described, a module, e.g., CSFB connection module 526 of FIG. 5, may be configured to override network-controlled cell selection/reselection and call establishment for CSFB/voice calls. Accordingly, the computer program product may include computer code for determining if ISR is active in an E-UTRAN in which a UE receives service at 800. If ISR is not active, the UE can operate in “normal” mode, (whether connected or idle) in accordance with, e.g., the LTE standard, at 805. The computer program product may further include computer code for determining if a call to be established is a voice call at 810. If the call to be established is not a voice call, operation can continue in normal mode at 805. Further still, the computer program product can include computer code camping on a legacy RAT network if the call to be established is determined to be a voice call at 820. Once the UE is camped on the legacy RAT network cell, the UE can establish connectivity for the voice call on the legacy RAT at 830.

Various embodiments have been described in the context of LTE, 2G, and 3G networks and standards. In accordance with various embodiments, and because a mobile device is registered on both RATs (i.e., 2G/3G and LTE) at the same time, the mobile device has liberty to choose what network to camp on, as well as what on network to establish a connection with on the uplink for both mobile terminated and mobile originated calls. Therefore camping on the network that has the best battery efficiency and establishing a connection with the fastest network provides a significant competitive advantage to the mobile device.

The various diagrams illustrating various embodiments may depict an example architectural or other configuration for the various embodiments, which is done to aid in understanding the features and functionality that can be included in those embodiments. The present disclosure is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement various embodiments. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

It should be understood that the various features, aspects and/or functionality described in one or more of the individual embodiments are not limited in their applicability to the particular embodiment with which they are described, but instead can be applied, alone or in various combinations, to one or more of the other embodiments, whether or not such embodiments are described and whether or not such features, aspects and/or functionality is presented as being a part of a described embodiment. Thus, the breadth and scope of the present disclosure should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

Moreover, various embodiments described herein are described in the general context of method steps or processes, which may be implemented in one embodiment by a computer program product, embodied in, e.g., a non-transitory computer-readable memory, including computer-executable instructions, such as program code, executed by computers in networked environments. A computer-readable memory may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

As used herein, the term module can describe a given unit of functionality that can be performed in accordance with one or more embodiments. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality. Where components or modules of the invention are implemented in whole or in part using software, in one embodiment, these software elements can be implemented to operate with a computing or processing module capable of carrying out the functionality described with respect thereto. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method, comprising:
determining whether a call to be established is intended to be serviced by a circuit switched network, while a user equipment (UE) is camped on a long term evolution (LTE) network; and
bypassing the LTE network, and establishing the call directly with the circuit switched network upon determining that the call is to be serviced by the circuit switched network.

2. The method of claim 1, wherein coverage areas of the LTE network and the circuit switched network overlap.

3. The method of claim 1, wherein the call comprises one of a mobile originated call and a mobile terminated call.

4. The method of claim 1, wherein the determination of whether the call to be established is intended to be serviced by the circuit switched network comprises analyzing a paging message sent by the LTE network when the call is a mobile terminated call.

5. The method of claim 4 further comprising, responding to the paging message via the circuit switched network.

6. The method of claim 1, wherein the determination of whether the call to be established is intended to be serviced by the circuit switched network comprises analyzing a service request message sent by the UE when the call is a mobile originated call originated at the UE.

7. The method of claim 1, wherein the circuit switched network comprises one of a Global System for Mobile Communications Radio Access Network (GERAN) and Universal Terrestrial Radio Access Network (UTRAN).

8. The method of claim 1, wherein the UE is registered in each of the LTE network and the circuit switched network, and wherein Idle Mode Signaling Reduction (ISR) is active in the LTE network.

9. An apparatus, comprising:
radio frequency (RF) circuitry to support communication with a plurality of radio access technology (RAT) network cells; and
a module for controlling establishment of circuit switched calls, such that the UE camps on one of the plurality of RAT network cells providing circuit switched connectivity if one of a mobile terminated call received by the apparatus or a mobile originated call initiated by the apparatus is a voice call.

10. The apparatus of claim 9, wherein the plurality of RAT network cells comprises at least one cell associated with a long term evolution (LTE) network and at least one cell associated with at least one of a 2^{nd} Generation (2G) wireless communication network and a 3^{rd} Generation (3G) wireless communication network.

11. The apparatus of claim 10, wherein the module bypasses initial servicing of the call via the LTE network when idle mode signaling reduction (ISR) is active within the LTE network.

12. The apparatus of claim 9, wherein respective coverage areas of the plurality of RAT network cells overlap.

13. The apparatus of claim 9, wherein the apparatus determines that the mobile terminated call is a voice call via a Paging Control Channel (PCCH) paging message received from an evolved Universal Terrestrial Radio Access Network (E-UTRAN) cell of the plurality of RAT network cells.

14. The apparatus of claim 13, wherein the apparatus responds to the PCCH paging message via one of a UTRAN or a Global System for Mobile Communications (GSM) Enhanced Data rates for GSM Evolution (EDGE) Radio Access Network (GERAN) cell of the plurality of RAT network cells.

15. The apparatus of claim 9, wherein the apparatus determines that the mobile originated call is a voice call via a Service Request message sent to a RAT network in which the one of the plurality of RAT network cells providing circuit switched connectivity is operative.

16. A computer program product, embodied on a non-transitory computer-readable medium, comprising:
computer code for determining if idle mode signaling reduction (ISR) is active in an evolved Universal Terrestrial Radio Access Network (E-UTRAN) in which a user equipment (UE) receives service;
computer code for determining if a call to be established is a voice call; and
computer code for camping on a legacy radio access technology (RAT) network and establishing connectivity for the call on the legacy RAT network if the call is a voice call.

17. The computer program product of claim 16, wherein the legacy RAT network comprises at least one of a UTRAN and a Global System for Mobile Communications (GSM) Enhanced Data rates for GSM Evolution (EDGE) Radio Access Network (GERAN).

18. The computer program product of claim 16, wherein the computer code for determining if the call to be established is a voice call comprises computer code for detecting presence of an Information Element (IE) within a paging message indicating the call is to be established in a circuit switched domain.

19. The computer program product of claim 18 further comprising, computer code for responding to the paging message via the legacy RAT network.

20. The computer program product of claim 16, wherein service areas associated with the E-UTRAN and the legacy RAT network overlap.
